(19) United States
(12) Patent Application Publication
(10) Pub. No.: US 2018/0085273 A1
(43) Pub. Date: Mar. 29, 2018

(54) Autonomous Urn For Discharging Powdery Mortal Remains From The Urn, As Well As A Method For Discharging Powdery Mortal Remains To The Ground

(71) Applicant: Wouter Klaas Jan Laurens, Wageningen (NL)

(72) Inventors: Wouter Klaas Jan Laurens, Wageningen (NL); Willem Laurens, Wageningen (NL)

(21) Appl. No.: 15/716,104

(22) Filed: Sep. 26, 2017

(30) Foreign Application Priority Data
Sep. 26, 2016 (NL) 2017537

(51) Int. Cl. A61G 17/08

(52) U.S. Cl. CPC A61G 17/08

(57) ABSTRACT

Urn for the autonomous discharge from the urn of powdery mortal remains such as ashes. The urn comprises a housing comprising a chamber for ashes, a discharge opening for the ashes, as well as a device for the batch-wise discharge of the powdery remains. For a reliable discharge of powdery mortal remains the device comprises

a transport organ for moving the powdery mortal remains to the discharge opening, and

an actuator for driving the transport organ;

wherein the urn is arranged for converting solar energy into a movement of the transport organ by means of the actuator.

The present invention relates to an urn for discharging powdery mortal remains from the urn, said urn comprising
a housing, said housing comprising a chamber for receiving the powdery mortal remains,
a discharge opening for the powdery remains, and
a device for discharging a portion of the powdery remains.

An autonomous urn according to the preamble is known from PCT/NL2007/000006. The urn disclosed there comprises an inlet-opening for rainwater. The urn known from this publication comprises a device for the batch-wise discharge of the powdery remains in the form of a reservoir having a siphon. When sufficient rainwater has been collected in the reservoir, it will drain via the siphon. Powdery mortal remains in the form of ashes are then entrained by the water and discharged via the discharge opening. If the urn is arranged above a hole in the ground, the ashes will end up in the ground over time. The urn is therefore autonomous, i.e. once the urn is installed no human intervention is necessary for the gradual discharge of the ashes to the ground.

Although the discharge will take place gradually, as is desired, the discharge process may become disrupted as a result of which the ashes may be discharged poorly or even not be discharged at all.

The object of the present invention is to provide an urn that is suitable for a more reliable discharge of powdery mortal remains to the ground.

To this end, an urn according to the preamble is characterized in that the device comprises
a transport organ for transporting the powdery mortal remains from the chamber to the discharge opening, and
an actuator for driving the transport organ;
   wherein the urn is arranged for converting solar energy selected from

i) sunlight, and

ii) solar heat,

into a movement of the transport organ by means of the actuator.

Powdery mortal remains are generally ashes obtained by cremation and optionally followed by grinding such as by means of a ball mill. Other methods for processing a corpse into a powdery material are known as well, such as a cryogenic method (freeze drying). For the sake of brevity only, hereinafter the term ashes will be used, without the invention being limited thereto.

Because of the use of solar energy, in the form of sunlight (using solar cells) or solar heat (changes in temperature) the urn can discharge ashes autonomously and gradually; wherein the ashes remain relatively dry, retain their ability to flow better and can be conveyed by the transport organ effectively.

According to a first possible embodiment the transport organ is a screw conveyor which at a first section of the screw conveyor is in communication with the chamber of the ashes and at a second section of the screw conveyor is in communication with the discharge opening for discharging ashes thereto. The urn may have a solar cell and an electric motor for driving the screw conveyor. In view of the required force advantageously a system for storage of electrical energy (such as a capacitor and preferably a battery) will be provided which, in case it is charged sufficiently or to a chosen degree, feeds an electric motor which will drive the screw via a gearbox. In this way powdery mortal remains are conveyed towards the discharge opening, wherein the screw conveyor is driven for a predetermined period and/or until a predetermined degree of discharge of the system for storage of electrical energy.

According to a favourable embodiment, at least part of the device selected from i) an actuator for driving the transport organ, and ii) the transport organ is housed in the chamber of the urn.

Thus, the device is at least partially hidden from view. For an urn based on solar heat preferably the entire device is housed in the chamber. For a device comprising a solar cell, this can be realized if the urn is made at least partially translucent for sunlight.

According to a favourable embodiment, the urn is arranged at its underside for connecting to a discharge tube for discharging powdery mortal remains via the discharge opening.

Such an urn can be placed easily and, in general thereafter, be provided with the powdery mortal remains.

According to a favourable embodiment, the urn comprises a discharge conduit of which a first end is in communication with the chamber and the discharge conduit provides the discharge opening at a distance of the first end, wherein the transport organ comprises at least two sealing bodies placed in line, arranged for

in a first position of the transport organ between a first sealing body that is placed relatively high and a second sealing body that is placed relatively low, letting in powdery mortal remains from the chamber and for blocking the flow through thereof to the discharge opening by the second sealing body, and

in a second position of the transport organ discharging the mortal remains to the discharge opening between the first sealing body and the second sealing body, wherein the first sealing body blocks the flow through of powdery mortal remains from the chamber.

The number of sealing bodies is advantageously at least three. Contact with the wall of the discharge conduit is not absolutely necessary for a seal, depending on the grain size of the powdery mortal remains and on bridge forming therein.

According to a favourable embodiment, the actuator is an actuator that converts heat into movement.

For the conversion of heat, the actuator for instance comprises a bimetal which will perform a to and fro movement caused by the changes in temperature. The movement can be a rotation or a translation.

According to a favourable embodiment, the actuator comprises a cylinder comprising a piston, which cylinder contains a working medium (332 the volume) of which varies depending on the temperature.

Day/night variations in the ambient temperature and/or variations throughout the day caused by different degrees of direct heating by the sun in case the urn is directly exposed to sun rays, will cause changes in the volume of the working medium, whereby the transport organ is driven by the piston of the actuator. The working medium will in general comprise a liquid. The piston may be an integral part of the transport organ.

If so desired, a linear movement of the piston may be converted into a hinging movement or rotation. For driving a screw conveyor for instance a ratchet may be used. Such a set-up can be achieved to a great extent independent of the degree of expansion of the working medium in a simple manner.

According to a favourable embodiment, the working medium is a super-expansive working medium of which the volumetric coefficient of expansion plotted against the temperature shows a peak, and the peak is present in a temperature range of −10° C. to 60° C.

A super-expansive working medium is a working medium that shows a non-linear expansion of >0.01% per ° C. for a (limited) temperature range, at which there is a transition point, i.e. a temperature at which the coefficient of expansion is larger than with the adjacent higher and lower temperature. The temperature-dependent expansion plotted against the temperature will then for instance show a sigmoid curve.

An example of a super-expansive working medium is water. Water is suitable since it expands when frozen. At the side of the piston, preferably a non-freezing liquid that does not mix with water such as an oil will be present, wherein the specific gravity of the non-freezing liquid and the orientation of the actuator will be chosen such that at the location of the piston non-freezing liquid is present.

According to a favourable embodiment, the super-expansive working medium is paraffin.

By adapting the formulation of the paraffin, the transition point can be chosen depending on the location of use of the urn. In a country located relatively close to one of the poles, a relatively low transition point will be chosen and in a country closer to the equator a relatively high transition point will be chosen. The transition point is generally between 25° C. and 55° C., wherein relatively high temperatures can be used for a placement of the urn in direct sunlight.

A typical value for the volumetric coefficient of expansion of paraffin in the range of super-expansion is >0.05% per ° C., and in a more limited temperature range it can even be >0.2% per ° C.

According to a favourable embodiment, the urn comprises a spring element which, at an increase of the volume of the working medium stores potential energy.

The force with which the working medium expands can be very strong, especially when the working medium is a non-gaseous working medium, but the force that can be exerted by the piston on the transport organ will in general be small when the volume of the working medium decreases. Thanks to the spring element which will be compressed when the volume of the working medium increases, with a returning movement also a large force can be exerted on the piston and the transport organ can be set into motion.

The spring element is for instance a spring, such as a leaf spring or a coil spring. For storing potential energy in a coil spring, the spring element may be pulled out or pushed in (compression spring).

According to a favourable embodiment, the device comprises a solar cell for conversion of sunlight into electric energy and the actuator is a motor.

Thus, an urn can be provided that can discharge powdery mortal remains to the ground on a daily basis. This can thus also take place faster than with the known urn that works using rainwater. It is also possible to do this at regular intervals through the use of an electronic control unit.

Finally, the present invention relates to method for discharging powdery mortal remains to the ground using an urn, said urn comprising
a housing, said housing comprising a chamber for receiving the powdery mortal remains,
a discharge opening for the powdery remains, and
a device for discharging a portion of the powdery remains;
   which method comprises the steps of, in arbitrary order

placing the urn in the open air, and

introducing the powdery mortal remains in the chamber of the urn; followed by the step of

gradually discharging powdery mortal remains present in the chamber of the urn to the ground via the discharge opening;

wherein the urn is an urn according to any of the claims 1 to 10; and solar energy is converted into a movement of the transport organ by means of the actuator.

Thus, the powdery mortal remains can be discharged to the ground gradually.

In the scope of the present invention ,Äúgradually,Äù means discharging powdery mortal remains for a period of more than 1 week in either regular or irregular intervals. In practice, this period may be many months or a few years.

The method also relates the use of each of the subclaims of the urn in any combination which, for the sake of brevity only, have not been repeated.

The present invention will now be illustrated with reference to the drawing where

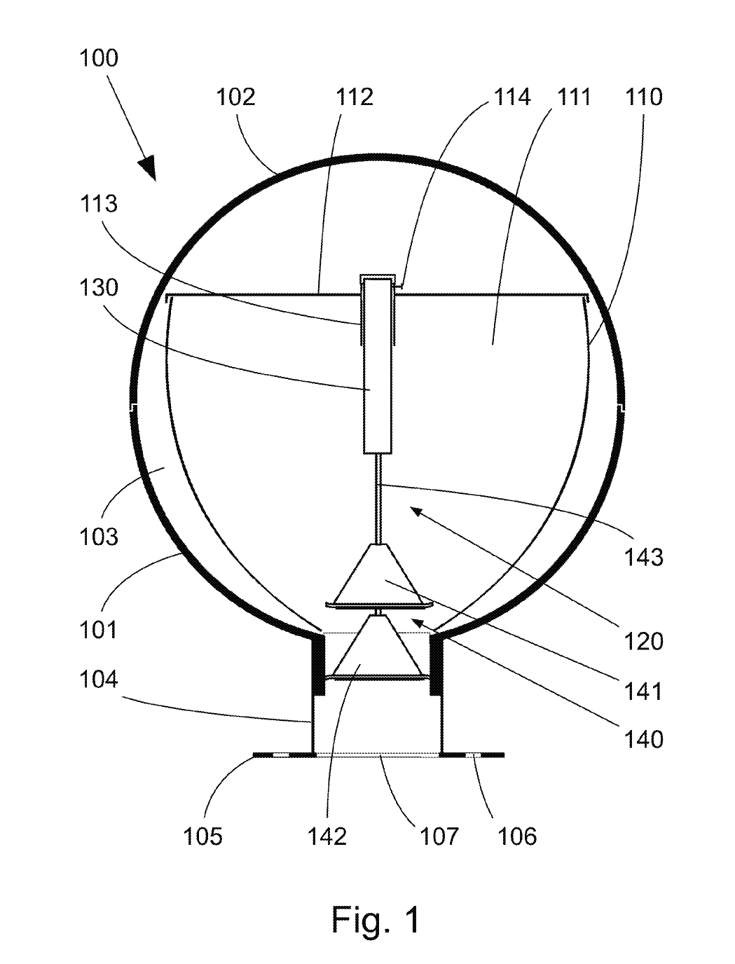

FIG. 1 shows a cross-section through an embodiment of an urn according to the invention;

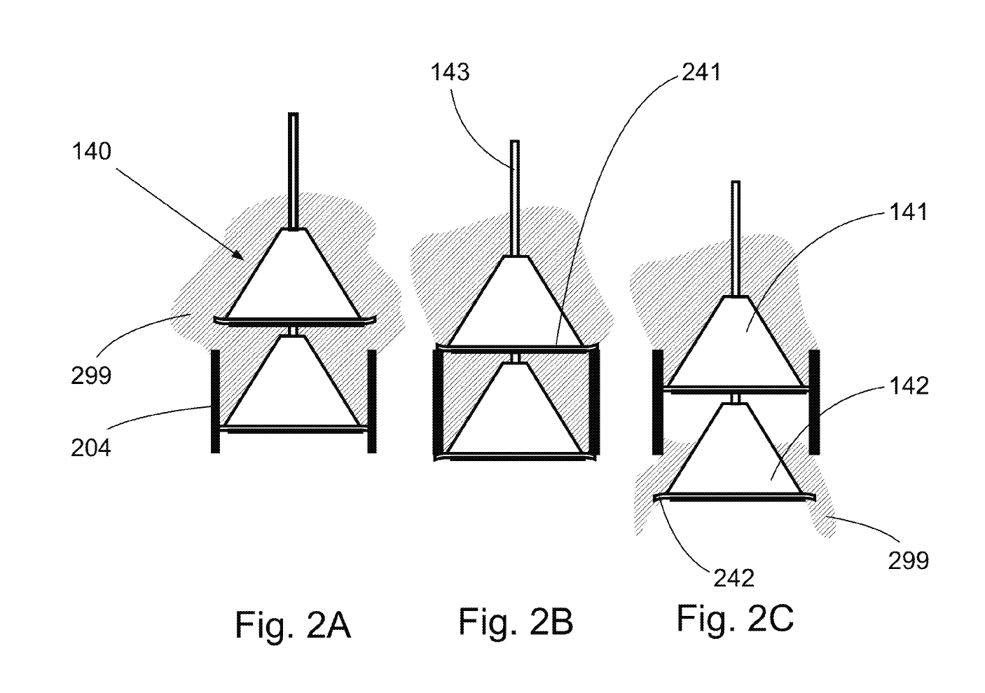

FIG. 2A to 2C show how a transport organ of the urn of FIG. 1 transports ashes;

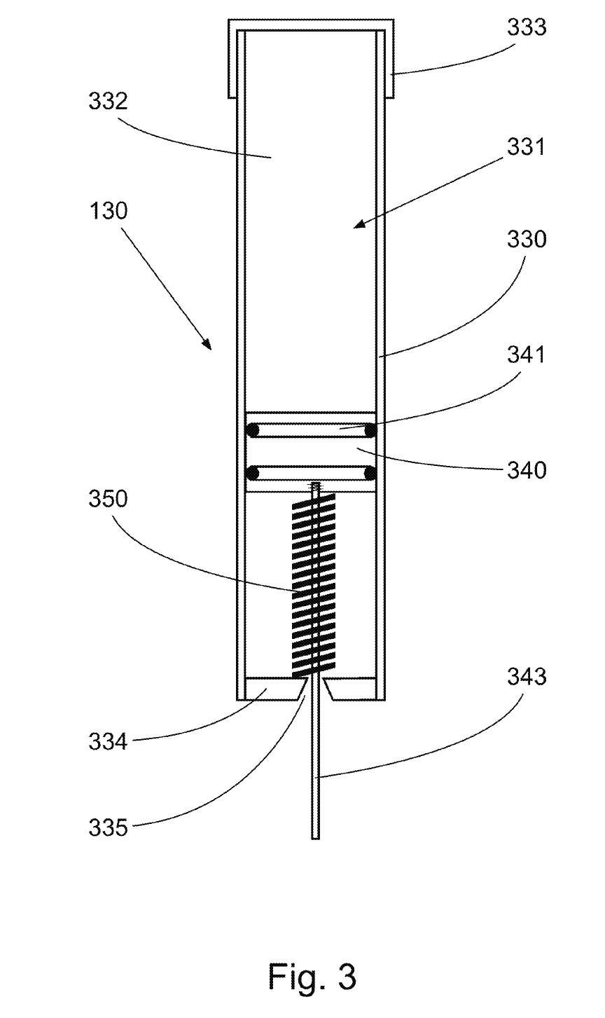

FIG. 3 shows a cross-section through an actuator of the urn of FIG. 1;

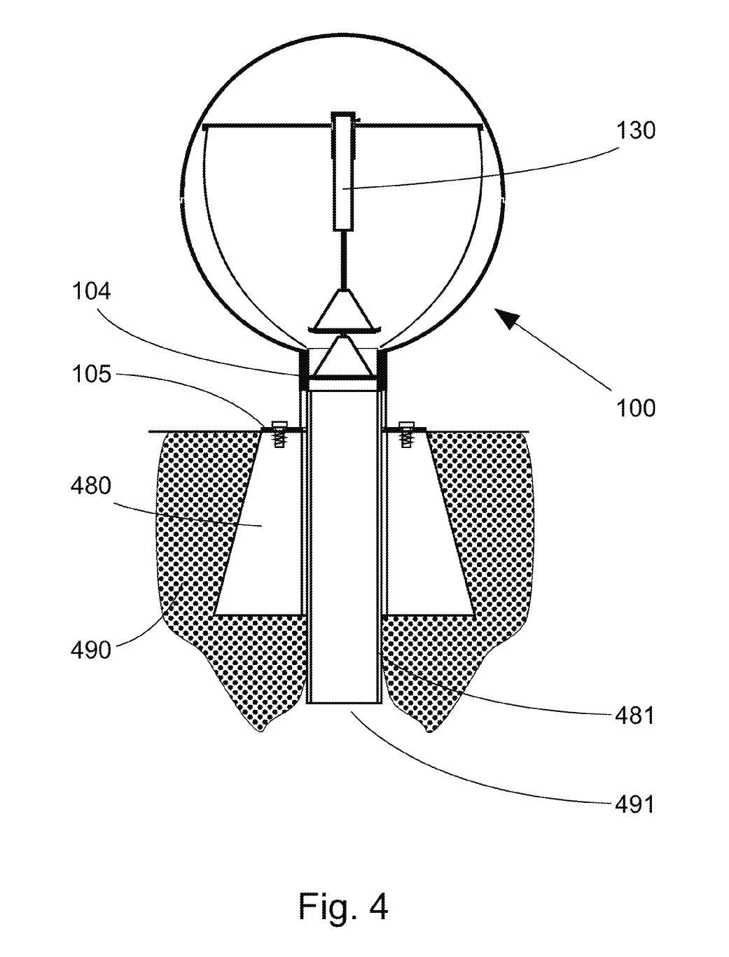

FIG. 4 shows the urn of FIG. 1 in a usage state for discharge of ashes to the ground; and

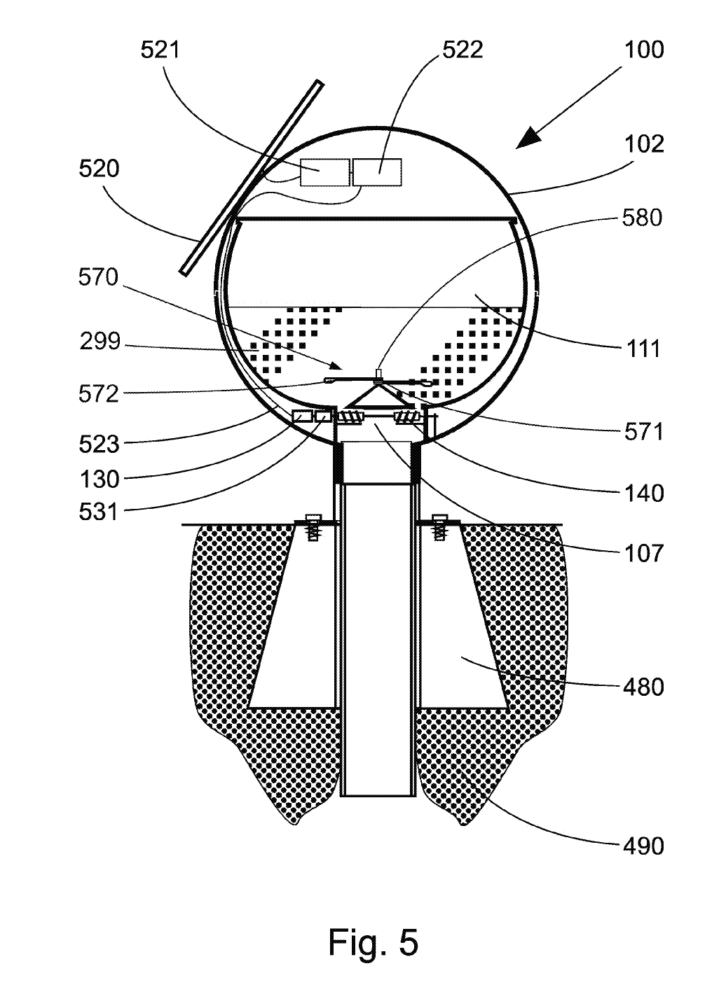

FIG. 5 shows an alternative urn according to the invention.

FIG. 1 shows a schematic cross-section through an autonomous urn 100 according to the invention, which with the embodiment illustrated here is an urn 100 which works on the basis of solar heat, more specifically, changes in temperature. The changes in temperature may be changes in temperature caused by changes in the intensity of solar radiation reaching the urn 100, or by changes of the ambient temperature (day/night).

The urn 100 comprises a first shell member 101, a second shell member 102 which connects to the first shell member 101, which shell members taken together provide a housing that provides for a chamber 103. The urn 100 further comprises a foot 104 provided with a mounting flange 105 having holes 106. The urn 100 comprises a discharge opening 107 via which ashes in the urn 100 can exit the urn 100 and be discharged to the ground (FIG. 4).

It can be seen that the chamber 103 is essentially isolated from the environment, more particularly that the urn 100 is arranged to principally keep rainwater falling on the urn 100 outside the chamber 103 of the urn 100. An hermetic seal is not necessary but (rain)watertight is favourable.

At least the second shell member 102 is advantageously made of metal, allowing the urn 100 to become hot particularly during summer. On a sunny day with an outdoor temperature of 22° C., in the urn 100 made of bronze and placed in the sun, a temperature of more than a 45° C. was measured. The inner urn 110 is covered with a metal lid 112 which conducts heat towards a metal sleeve 113.

With the embodiment illustrated here an inner urn 110 is provided with a lumen 111 in which the ashes of a deceased person or animal can be placed.

The urn 100 comprises a device 120 comprising an actuator 130 which is received in the sleeve 113 and is secured using a small bolt 114. The device 120 further comprises a transport organ 140 which in the embodiment shown here comprises an upper first sealing body 141 and a lower second sealing body 142 mounted on a pen 143. The actuator 130 can make the transport organ 140 move up and down, depending on the temperature of the actuator 130.

FIG. 2A until 2C shows how a transport organ 140 of the urn 100 of FIG. 1 transports ashes batch-wise. The pen 343 moves up and down by the action of the actuator 130, generally with a daily rhythm of 1 full stroke a day.

FIG. 2A shows the transport organ 140 in a relatively high position, wherein ashes 299 from the lumen 111 can flow into a tubular channel 204, wherein the second sealing body 142 prevents the ashes 299 from flowing further downward.

When the pen 343 is moved further downward by the actuator 130, the upper first sealing body 141 also will close off the tubular channel 204 (FIG. 2B).

When the pen 343 is moved even further downward, the ashes 299 can flow from the tubular channel 204 and exit the urn 100 via the discharge opening 107 (FIG. 2C), wherein the upper first sealing body 141 still closes off the tubular channel 204 and prevents the ashes 299 from flowing freely from the lumen 111.

In the embodiment illustrated here, the sealing bodies are in the shape of a cone, with the tapering ends directed upwardly, be it in order to be fed more easily through the ashes in the lumen 111, or to entirely or almost entirely discharge the ashes between the first sealing body 141 and the second sealing body 142.

In the embodiment illustrated here, the sealing bodies have been equipped with a first disk 241 respectively second disk 242 of elastic material such as silicone-rubber. Advantageously, of at least one sealing body the entire sealing body is made of silicone-rubber.

In an environment where the changes in temperature can be great, for a device according to the invention that uses a transport organ comprising sealing elements on an axis more than two sealing bodies may be provided such as at least three. Thus, with relatively small to and fro strokes, ashes can be discharged in more than 1 range of temperature, while also with large changes in temperature it is avoided that ashes flow out of the lumen 111 through the discharge opening 107 unimpeded.

FIG. 3 shows a cross-section through the actuator 130 of the urn 100 of FIG. 1. The actuator comprises a cylinder 330 provided with a piston 340 having two sealing rings 341. In the cylinder chamber 331 paraffin is present as a working medium 332. The cylinder chamber 331 is sealed with a screw cap 333.

When the paraffin expands, a large force is exerted and the piston 340 slides within the cylinder chamber 331 outwardly (downwardly), as a result of which the transport organ 140 moves downwardly. A piston rod can be seen which here is the pen 143 which at one end is provided with screw thread which in a corresponding cavity provided with internal screw thread is attached to the piston 340.

When the paraffin cools down it cannot exert such a large force. In the embodiment described here of an urn 100 according to the invention, the actuator 130 is provided with a spring element 350 (coil spring 350) which, upon expansion of the working medium will be compressed against a false bottom 334 provided with a conical hole 335 and upon shrinkage of the working medium pushes the piston 340 up as a result of which the transport organ 140 can be moved upward with force.

The conical hole 335 is helpful when installing the actuator 130. The pen 143 is inserted through the hole 335 (which for that reason is preferably tapered), subsequently by rotating of the actuator 130 is attached to the piston 340.

FIG. 4 shows the urn 100 of FIG. 1 mounted on a socle 480 provided with a tube 481, wherein the mounting flange 105 is attached to the socle 480 using bolts. The tube 481 is inserted in a drilled hole 491 in the ground 490. When ashes 299 exit the urn 100 via the discharge opening 107, these will fall downward via the tube 481 and end up in the ground 490.

FIG. 5 shows an alternative urn 100 according to the invention, which works on sunlight. The device 120 comprises a solar cell 520, a rechargeable battery 521, and a module with control electronics 522. The actuator 130 is a motor which drives a screw conveyor via a gearbox 531, which screw conveyor is the transport organ 140. The screw conveyor comprises two sections having opposite windings, as a result of which with a single direction of rotation of the transport organ ashes can be fed toward the discharge opening 107 from two locations in the urn 100.

Sunlight reaching the urn 100 will charge the battery 521. When it has been sufficiently charged, the module containing the control electronics 522 ensures that the motor is fed via live wire 523 and starts to rotate, and ashes from the lumen 111 are conveyed to the discharge opening 107 by means of the screw conveyor and discharged to the ground.

With the urn according to the invention a device may be present capable of moving under influence of changing humidity of the ashes and/or under the influence of changing temperature in the ashes. This movement moves the ashes which may contribute to counter bridge formation in the ashes and/or by allowing a cavity formed by bridge formation to collapse. In the embodiment shown in FIG. 5, the auxiliary device 570 comprises a coiled element 571 with two arms 572, which element 571 preferably comprises a bimetal. The arms 572 are capable of moving freely because the element is placed over an upright pin 580 with clearance.

1. An urn for discharging powdery mortal remains from the urn, said urn comprising
a housing, said housing comprising a chamber for receiving the powdery mortal remains,
a discharge opening for the powdery remains, and
a device for discharging a portion of the powdery remains;
characterized in that the device comprises
a transport organ for transporting the powdery mortal remains from the chamber to the discharge opening, and
an actuator for driving the transport organ;
wherein the urn is arranged for converting solar energy selected from
i) sunlight, and
ii) solar heat,
into a movement of the transport organ by means of the actuator.

2. The urn according to claim 1, wherein at least part of the device selected from i) an actuator for driving the transport organ, and ii) the transport organ is housed in the chamber of the urn.

3. The urn according to claim 1, wherein the urn is arranged at its underside for connecting to a discharge tube for discharging powdery mortal remains via the discharge opening.

4. The urn according to claim 1, wherein the urn comprises a discharge conduit of which a first end is in communication with the chamber and the discharge conduit provides the discharge opening at a distance of the first end, wherein the transport organ comprises at least two sealing bodies placed in line, arranged for
in a first position of the transport organ between a first sealing body that is placed relatively high and a second sealing body that is placed relatively low, letting in powdery mortal remains from the chamber and for blocking flow through thereof to the discharge opening by the second sealing body, and
in a second position of the transport organ discharging the mortal remains to the discharge opening between the first sealing body and the second sealing body, wherein the first sealing body blocks flow through of powdery mortal remains from the chamber.

5. The urn according to claim 1, wherein the actuator converts heat into movement.

6. The urn according to claim 5, wherein the actuator comprises a cylinder comprising a piston, which cylinder contains a working medium the volume of which varies depending on its temperature.

7. The urn according to claim 6, wherein the working medium is a super-expansive working medium of which its volumetric coefficient of expansion plotted against its temperature shows a peak, and the peak is present in a temperature range of −10° C. to 60° C.

8. The urn according to claim 7, wherein the super-expansive working medium is paraffin.

9. The urn according to claim 6, wherein the urn comprises a spring element which, at an increase of volume of the working medium stores potential energy.

10. The urn according to claim 1, wherein the device comprises a solar cell for conversion of sunlight into electric energy and the actuator is a motor.

11. A method for discharging powdery mortal remains to the ground using an urn, said urn comprising
a housing, said housing comprising a chamber for receiving the powdery mortal remains,
a discharge opening for the powdery remains, and
a device for discharging a portion of the powdery remains;
which method comprises the steps of, in arbitrary order
placing the urn in the open air, and
introducing the powdery mortal remains in the chamber of the urn; followed by the step of
gradually discharging powdery mortal remains present in the chamber of the urn to the ground via the discharge opening;
characterized in that the urn is an urn according to claim 1; and
solar energy is converted into a movement of the transport organ by means of the actuator.
